(19) United States
(12) Patent Application Publication
(10) Pub. No.: US 2022/0321588 A1
(43) Pub. Date: Oct. 6, 2022

(54) ANOMALY DETECTION FOR NETWORKING

(71) Applicant: Marvell Israel (M.I.S.L) Ltd., Yokneam (IL)

(72) Inventors: Gideon Navon, Tel-Aviv (IL); Ziv Tomarov, Ramat-Gan (IL); Yaron Kittner, Pardes Hanna-Karkur (IL)

(21) Appl. No.: 17/714,044

(22) Filed: Apr. 5, 2022

Related U.S. Application Data
(60) Provisional application No. 63/170,944, filed on Apr. 5, 2021.
(60) Provisional application No. 63/208,879, filed on Jun. 9, 2021.

(51) Int. Cl. H04L 9/40

(52) U.S. Cl. CPC H04L 63/1425; H04L 63/1441

(57) ABSTRACT

An anomaly detection apparatus for detecting anomalies in network traffic includes a statistics generator that receives characteristics of packets in network traffic and to generate statistics for the network traffic. The statistics include distribution statistics regarding respective distributions of respective characteristics of packets in the network traffic over time. An anomaly detection processor detects deviations in the distribution statistics as compared to distribution statistics for normal network traffic and detects anomalies regarding the network traffic based on the deviations in the distribution statistics as compared to distribution statistics for the normal network traffic.

### CROSS REFERENCES TO RELATED APPLICATIONS

This application claims the benefit of U.S. Provisional Patent Application No. 63/170,944, entitled “Novel Feature Extractor for an Ensemble of Autoencoders,” filed on Apr. 5, 2021, and claims the benefit of U.S. Provisional Patent Application No. 63/208,879, entitled “Online Feature Extractor & Ensemble of Autoencoders for High-Rate Anomaly Detection in Networking,” filed on Jun. 9, 2021. Both of the applications referenced above are incorporated herein by reference in their entireties for all purposes.

### FIELD OF TECHNOLOGY

The present disclosure relates generally to network communications, and more particularly to detecting anomalies in network traffic.

### BACKGROUND

Anomaly detection systems are used to detect anomalies in network traffic that may be due, for example, to a malicious network intrusion, network device failure or malfunction, new traffic patterns, etc. Some anomaly detection systems use machine learning techniques to detect anomalies in network traffic. However, the packet rate of modern networks is high and ever-increasing, and thus implementation of commercially viable anomaly detection systems that can operate at the necessary speeds is challenging.

Network anomaly detection systems can be located within a network device (e.g., a switch, a router, a bridge, a network interface card (NIC), etc.), or in a central location serving many networking devices.

Some network anomaly detection systems use machine learning (e.g., an artificial neural network). It is challenging, however, to detect anomalies while keeping costs of the system to a commercially viable level if the Machine Learning algorithm/hardware is processing new data and/or making a determination of whether an anomaly is detected at a rate at which packets are being transmitted in the network.

### SUMMARY

In an embodiment, an anomaly detection apparatus for detecting anomalies in network traffic comprises: a statistics generator configured to receive characteristics of packets in network traffic and to generate statistics for the network traffic, the statistics including distribution statistics regarding respective distributions of respective characteristics of packets in the network traffic over time; and an anomaly detection processor configured to detect anomalies regarding the network traffic based at least the statistics generated by the statistics generator, including detecting deviations in the distribution statistics as compared to distribution statistics for normal network traffic and detecting anomalies regarding the network traffic based on the deviations in the distribution statistics as compared to distribution statistics for the normal network traffic.

In another embodiment, a method for detecting anomalies in network traffic includes: receiving, at feature extraction circuitry, characteristics of packets in network traffic; generating, at the feature extraction circuitry, statistics for the network traffic, the statistics including distribution statistics regarding respective distributions of respective characteristics of packets in the network traffic over time; and detecting, at an anomaly detection processor, anomalies regarding the network traffic based at least the statistics generated by the statistics generator, including detecting deviations in the distribution statistics as compared to distribution statistics for normal network traffic and detecting anomalies regarding the network traffic based on the deviations in the distribution statistics as compared to distribution statistics for the normal network traffic.

### BRIEF DESCRIPTION OF THE DRAWINGS

FIG. 1 is a simplified diagram of an example network traffic anomaly detection system that comprises a feature extraction system and an anomaly detection processor, according to an embodiment.

FIG. 2A is a simplified block diagram of the anomaly detection processor of FIG. 1, according to an embodiment.

FIG. 2B is a simplified block diagram of the anomaly detection processor of FIG. 1, according to another embodiment.

FIG. 2C is a simplified block diagram of the anomaly detection processor of FIG. 1, according to another embodiment.

FIG. 3 is a flow diagram of an example method for detecting anomalies in network traffic, according to an embodiment.

FIG. 4 is a simplified block diagram of an example network device that incorporates the feature extraction system and the anomaly detection processor of FIG. 1, according to an embodiment.

FIG. 5 is a simplified block diagram of an example system that includes multiple network devices and the anomaly detection processor of FIG. 1, each network device incorporating a respective feature extraction system of FIG. 1, according to an embodiment.

### DETAILED DESCRIPTION

Various embodiments of network traffic anomaly detection systems are described below. In some embodiments, an anomaly detector of a network traffic anomaly detection system is configured to i) operate at a rate that is lower than a packet rate and ii) use network traffic statistics that provide information regarding multiple packets. For example, the rate at which the anomaly detector operates corresponds to a time period having a duration at least as long as the aggregate time of the transmission of multiple packets. In some embodiments, the cost of such an anomaly detector is significantly less as compared to an anomaly detector that operates at the packet rate, e.g., processing new data and/or making a determination of whether an anomaly is detected at a rate at which packets are being transmitted in the network.

In other embodiments, the network anomaly detection system additionally or alternatively is configured to i) generate distribution statistics (a particular type of network traffic statistics) regarding a distribution of respective characteristics of packets (e.g., a packet length, a duration of an inter-packet gap, etc.) in the network traffic over time, and ii) use the distribution statistics to detect anomalies in the network traffic. As merely an illustrative example, the network anomaly detection system uses a distribution of sizes of packets in a traffic flow over time, and detects an anomaly based on at least a significant deviation in the traffic flow from the distribution of sizes of packets. In some embodiments, such distribution statistics are generated at a rate that is lower than the packet rate, which facilitates an anomaly detector to operate at a rate that is lower than the packet rate.

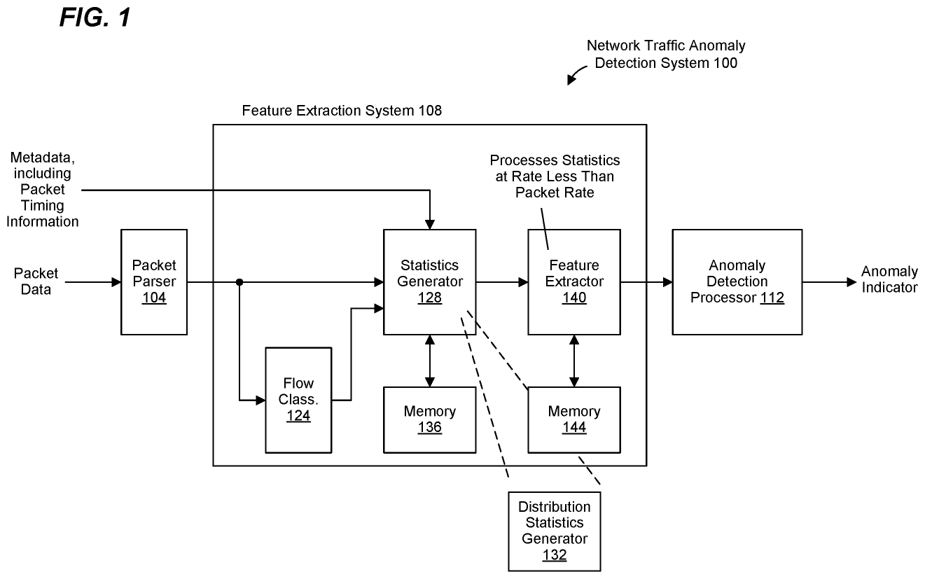

FIG. 1 is a simplified diagram of an example network traffic anomaly detection system 100, according to an embodiment. The network traffic anomaly detection system 100 detects anomalies in network traffic corresponding to malicious network intrusions, network device failures or malfunctions, new traffic patterns, etc.

The network traffic anomaly detection system 100 comprises a packet parser 104, a feature extraction system 108 coupled to the packet parser 104, and an anomaly detection processor 112 coupled to the feature extraction system 108. The packet parser 104 generally extracts information from packets in network traffic and provides the extracted information to the feature extraction system 108. The feature extraction system 108 generally uses information extracted from packets and timing information related to the packets to generate statistical information regarding the packets. The anomaly detection processor 112 generally uses the statistical information from the feature extraction system 108 to detect anomalies in the network traffic.

As briefly discussed above, the packet parser extracts information from packets in network traffic. More specifically, the packet parser 104 is configured to receive packet data corresponding to packets transmitted in a network (i.e., network traffic), and to extract information from the packets, according to some embodiments. As an example, the packet parser 104 is configured to extract header information from a packet such as an Internet Protocol (IP) source address, an IP destination address, a Layer-2 source address (e.g., a media access control (MAC) source address), a Layer-2 destination address (e.g., a MAC destination address), a transmission control protocol (TCP) source port identifier (ID), a TCP destination port ID, a user datagram protocol (UDP) source port ID, a UDP destination port ID, an IP version identifier, a packet length, etc.

The feature extraction system 108 is configured to receive at least some of the information extracted by packet parser 104. In some embodiments, the feature extraction system 108 is also configured to receive packet metadata that includes timing information regarding packets in the network traffic. For example, the feature extraction system 108 is configured to receive timing information that indicates one or more of: i) a time at which a network device (e.g., a network device that includes the packet parser 104) began receiving a packet (i.e., an arrival time), ii) a time at which the packet was transmitted (i.e., a transmitted time), iii) a time at which reception of the packet at the network device ended, iv) a time duration of transmission of the packet, v) a time duration of a gap between packets, vi) a length of the packet, etc. In some embodiments, the metadata includes other information regarding the packet such as a port (or interface) at which the packet was received, a port (or interface) via which the packet is to be transmitted, error codes generated by a packet processor (of a network device) that processed the packet, etc.

The metadata is generated by a network device associated with the network traffic anomaly detection system 100 and provided by the network device to the network traffic anomaly detection system 100. In some embodiments, the feature extraction system 108 is included in a network device such as a switch, a router, etc., that is configured to receive packets via multiple network links and to forward the packets via multiple network links, and the metadata is generated by the network device. In some embodiments in which the feature extraction system 108 is included in a network device such as a switch, a router, etc., the packet parser 104 is a component of the network device and packet information generated by the packet parser 104 is also used by the network device to process packets (e.g., determine via which ports of the network device to forward packets received by the network device, determine how to modify packets (e.g., whether to add a tunneling header to the packet, whether to remove a tunneling header from the packet, whether to update a next hop address in the packet, etc.) received by the network device, etc.).

As will be described further below, the feature extraction system 108 uses i) the information extracted from the packets by the packet parser 104 and/or ii) the packet metadata to generate statistics regarding network traffic corresponding to the packets processed by the packet parser 104. Examples of statistics generated by the feature extraction system 108 are described further below. In some embodiments, the statistics generated by the feature extraction system 108 include distribution statistics regarding distributions of respective characteristics of packets in the network traffic. Examples of distribution statistics (which are described further below) include a distribution of packet size in the network traffic during a time period (or during transmission of a set of N packets, where N is a suitable integer greater than one) and a distribution of inter-packet gap size during the time period (or during the set of N packets). Illustrative and non-limiting examples of N include 100, 200, 300, etc.

The feature extraction system 108 also generates respective sets of information (sometimes referred to as “feature vectors”) that provide information regarding network traffic during respective time periods or during transmission of respective sets of N packets. The respective sets of information generated by the feature extraction system 108 include at least statistics (including distribution statistics, in some embodiments) for network traffic during respective time periods or during transmission of respective sets of N packets.

The respective sets of information (or feature vectors) generated by the feature extraction system 108 are provided to the anomaly detection processor 112. The anomaly detection processor 112 is configured to process the feature vectors to detect anomalies regarding the network traffic. In some embodiments, the anomaly detection processor 112 is configured to generate an indicator of whether an anomaly is detected regarding the network traffic based on the processing of the feature vectors. In some embodiments, the indicator of whether an anomaly is detected comprises a score that indicates a degree of deviation from normal network traffic behavior.

In some embodiments, the anomaly detection processor 112 comprises a machine learning engine that is trained to detect anomalies in network traffic based on feature vectors. For example, the anomaly detection processor 112 is trained on network traffic that is assumed to be normal and thus the anomaly detection processor 112 learns statistical patterns of normal network traffic. After training, if the statistics monitored by the anomaly detection processor 112 deviate from statistics of normal network traffic to a significant degree, the output generated by the anomaly detection processor 112 may indicate an anomaly in the network traffic.

In some embodiments, the anomaly detection processor 112 comprises a support vector machine. In some embodiments, the anomaly detection processor 112 comprises a Bayesian network.

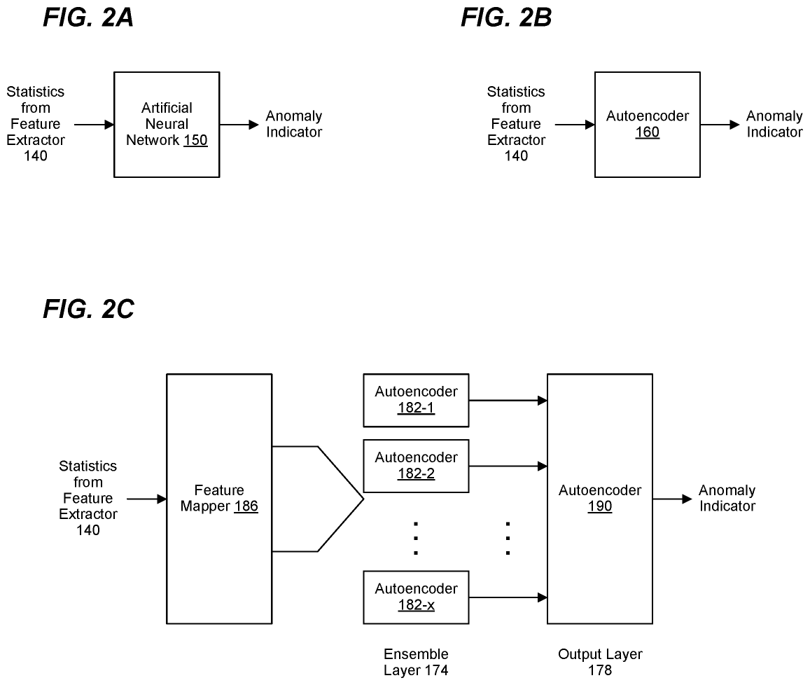

Referring to FIG. 2A, in some embodiments the anomaly detection processor 112 comprises an artificial neural network 150. Referring to FIG. 2B, in some embodiments the anomaly detection processor 112 comprises an autoencoder 160, e.g., a single autoencoder 160.

Referring to FIG. 2C, the anomaly detection processor 112 comprises a plurality of autoencoders arranged in an ensemble layer 174 and an output layer 178, according to an embodiment. The ensemble layer 174 comprises multiple autoencoders 182. A feature mapper 186 is coupled to the ensemble layer 174. The feature mapper 186 receives feature vectors from the feature extractor 140 and provides each autoencoder a respective subset of features (a respective subspace) from each feature vector. Each autoencoder 182 is configured to process the respective subspace to generate a respective subspace score indicating a degree of deviation from normal behavior of the subspace.

The output layer comprises an autoencoder 190, e.g., a single autoencoder 190, according to an embodiment. The autoencoder 190 receives the subspace scores generated by the multiple autoencoders 182 and is configured to generate a final score using the subspace scores, the final score indicating a degree of deviation from normal network traffic behavior. In an embodiment, the final score corresponds to an anomaly indicator.

Referring again to FIG. 1, in some embodiments the anomaly detection processor 112 comprises a statistical-based detection engine that implements a suitable algorithm, such as a standard score algorithm, a Tukey's range test, a Grubb's test, etc., on the feature vectors to detect anomalies regarding the network traffic.

The feature extraction system 108 comprises a flow classifier 124 that is configured to process header information extracted from a packet by the packet parser 104 to determine a flow to which the packet belongs. In an embodiment, the flow classifier 124 defines a flow as packets that share a same set of header information. In some embodiments, the same set of header information includes a network source address (e.g., a source IP address, a source MAC address, or another suitable network address), and a network destination address (e.g., a destination IP address, a destination MAC address, or another suitable network address). In an illustrative embodiment, the same set of header information includes a source IP address, a source TCP/UDP port, a destination IP address, a destination TCP/UDP port, and an IP version identifier. In an embodiment, the same set of information includes a source IP address, a source TCP/UDP port, a destination IP address, a destination TCP/UDP port, and an IP version identifier. In other embodiments, a flow identified by the flow classifier 124 corresponds to another suitable same set of header information such as corresponding to packets intended for a same endpoint, corresponding to packets intended to be forwarded to a same intermediate device (e.g., a same switch, router, bridge, etc.), etc.

In some embodiments, the flow classifier 124 generates flow classification information that indicates a flow to which a packet belongs. In an embodiment, the flow classification information includes a flow identifier (ID) that identifies a flow to which a packet belongs.

In other embodiments, such as embodiments in which the feature extraction system 108 is incorporated in a network device (such as a switch, router, bridge, etc.) that is configured to process packets and to make forwarding decisions for packets (e.g., determine one or more ports of the network device via which a packet is to be transmitted), the flow classifier 124 is omitted from the feature extraction system 108 and the feature extraction system 108 essentially considers packets that are being transmitted via a same port of the network device (and/or enqueued in a same queue of the network device for transmission) as belonging to a same flow. In some such embodiments, the determination that multiple packets are to be transmitted via a same port (or the enqueuing of packets in a same queue) may be considered as classifying by the network device the packets as belonging to a same flow. In some embodiments, multiple queues of the network device may correspond to a same network link, and where respective ones of the multiple queues correspond to different transmission priorities.

Accordingly, the term “flow” as used herein refers to a set of packets having a same set of set of header information, and/or to packets that are determined by a network device to be transmitted via a same port of the network device, and/or to packets enqueued in a same queue by a network device for transmission by the network device.

A statistics generator 128 receives header information extracted from the packet by the packet parser 104, flow classification information from the flow classifier 124, and packet metadata. The statistics generator 128 is configured to generate statistics regarding packet data using at least the flow classification information from the flow classifier 124, and packet metadata. In embodiments in which the flow classifier 124 is omitted (e.g., embodiments in which the feature extraction system 108 processed packets enqueued by a network device in queues), the statistics generator 128 does not receive flow classification information and does not use flow classification information to generate statistics.

More specifically, the statistics generator 128 is configured to generate statistics regarding characteristics of network traffic in first time windows that each correspond to the transmission of multiple packets. In some embodiments, the first time windows are non-overlapping time windows that do not overlap in time with other time windows.

In other embodiments, the first time windows are sliding windows that overlap in time with other first time windows.

In an embodiment, each first time window corresponds to a predetermined amount of time. As merely illustrative examples, each first time window has a time duration of 200 microseconds, 500 microseconds, 1 second, etc., or any other suitable time duration. In another embodiment, each first time window corresponds to a predetermined number of packets in the network traffic. As merely illustrative examples, each first time window corresponds to 200 packets, 300 packets, 500 packets, 1000 packets, etc., or any other suitable number of packets. In some embodiments, the predetermined number of packets is a predetermined number of packets in a flow for which statistics are being generated.

Examples of statistics regarding characteristics of network traffic in time windows generated by the statistics generator 128 include: i) a packet rate during the time window (e.g., a number of packets divided by a time duration of the time window), ii) a data rate during the time window (e.g., an aggregate number of bits divided by the time duration of the window, iii) an average packet size during the time window, iv) a minimum packet size during the time window, v) a maximum packet size during the time window, vi) a minimum inter-packet gap (IPG) size during the time window, vii) a maximum IPG size during the time window, viii) an average IPG size during the time window. In various embodiments, the statistics generator 128 is configured to generate one of or any suitable combination of two or more of the statistics described above.

In some embodiments, the statistics generator 128 includes a distribution statistics generator 132 that is configured to generate distribution statistics regarding respective distributions of respective characteristics of packets in the network traffic over time. In an embodiment, the distribution statistics generator 132 is configured to generate distribution statistics regarding a distribution of packet size over each first time window. For example, a plurality of packet size ranges (sometimes referred to herein as “packet size bins”) are defined, and the distribution statistics generator 132 records a respective number of packets that correspond to the respective packet size range (or bin) during the first time window. In an illustrative embodiment, a number of packet size bins is eight. In other embodiments, the number of packet size bins is a suitable number other than eight.

In various other examples, the distribution statistics generator 132 generates one of, or any suitable combination of two or more of: an average deviation of packet size from the mean packet size during the first time window, a means square deviation of packet size from the mean packet size during the first time window, etc.

In another embodiment, the distribution statistics generator 132 additionally or alternatively is configured to generate distribution statistics regarding a distribution of IPG sizes over each first time window. For example, a plurality of IPG size ranges (sometimes referred to herein as “IPG size bins”) are defined, and the distribution statistics generator 132 records a respective number of IPGs that correspond to the respective IPG size range (or bin) during the first time window. In an illustrative embodiment, a number of IPG size bins is eight. In other embodiments, the number of IPG size bins is a suitable number other than eight.

In various other examples, the distribution statistics generator 132 generates one of, or any suitable combination of two or more of: an average deviation of IPG size from the mean IPG size during the first time window, a means square deviation of IPG size from the mean IPG size during the first time window, etc.

In some embodiments, the statistics generator 128 omits the distribution statistics generator 132 and does not generate distribution statistics such as described above.

In some embodiments, the statistics generator 128 generates some or all of the statistics described above, including distribution statistics, per flow. In some embodiments, the first time window over which statistics are generated for a flow corresponds to a particular number of packets in the flow, e.g., 100 packets in the flow, 200 packets in the flow, 300 packets in the flow, etc. In other embodiments, the first time window over which statistics are generated for a flow corresponds to a particular number of packets regardless of the flows to which the packets belong. In other embodiments, the first time window over which statistics are generated for a flow corresponds to a particular time duration, e.g., 200 microseconds, 300 microseconds, 1 second, etc.

In various embodiments, the statistics generator 128 generates one of, or any suitable combination of two or more of: i) a packet rate of packets belonging to the flow during the time window (e.g., a number of packets divided by a time duration of the window), ii) a data rate of packets belonging to the flow during the time window (e.g., an aggregate number of bits in the flow divided by the time duration of the window, iii) an average packet size of packets belonging to the flow during the time window, iv) a minimum packet size of packets belonging to the flow during the time window, v) a maximum packet size of packets belonging to the flow during the time window, vi) a minimum IPG size between packets belonging to the flow during the time window, vii) a maximum IPG size between packets belonging to the flow during the time window, viii) an average IPG size between packets belonging to the flow during the time window, etc.

In some embodiments in which the statistics generator 128 includes the distribution statistics generator 132, the distribution statistics generator 132 is configured to generate distribution statistics regarding respective distributions of respective characteristics of packets per flow, i.e., for packets having a same set of header information (e.g., a same set of a source address, a destination address, etc.). For instance, in various embodiments, the distribution statistics generator 132 is configured to generate one of, or any suitable combination of two or more of: i) distribution statistics regarding a distribution of packet size in a flow over each time window (e.g., the distribution statistics generator 132 records a respective number of packets in a flow that correspond to the respective packet size range during the time window for packets in the flow), ii) an average deviation of packet size from the mean packet size during the time window for packets in the flow, iii) a means square deviation of packet size from the mean packet size during the time window for packets in the flow, iv) distribution statistics regarding a distribution of IPG sizes for a flow over each time window (e.g., the distribution statistics generator 132 records a respective number of IPGs between packets in the flow that correspond to the respective IPG size range during the time window), v) an average deviation of IPG size from the mean IPG size for packets in the flow during the time window, vi) a means square deviation of IPG size from the mean IPG size for packets in the flow during the time window, etc.

The statistics generator 128 is coupled to a memory 136 and uses the memory 136 to generate and store statistics such as described above.

A feature extractor 140 is coupled to the statistics generator 128. The feature extractor 140 generates feature vectors based on the statistics generated by the statistics generator 128. For instance, in some embodiments the feature extractor 140 generates new statistics by mathematically combining multiple statistics generated by the statistics generator 128, compiling multiple distribution statistics generated by the statistics generator 128 for multiple first time windows to generate distribution statistics for a longer second time window, etc. As an illustrative example, the feature extractor 140 mathematically combines multiple average packet size statistics for multiple first time windows to generate an average packet size for a longer second time window that corresponds to the multiple first time windows. As another illustrative example, the feature extractor 140 mathematically combines multiple average IPG size statistics for multiple first time windows to generate an average IPG size for a longer second time window that corresponds to the multiple first time windows. As another illustrative example, the feature extractor 140 mathematically combines multiple average deviations from mean packet size statistics for multiple first time windows to generate an average deviation from mean packet size for a longer second time window that corresponds to the multiple first time windows. As another illustrative example, the feature extractor 140 mathematically combines multiple average deviations from mean IPG size statistics for multiple first time windows to generate an average deviation from mean IPG size for a longer second time window that corresponds to the multiple first time windows.

As another illustrative example, the feature extractor 140 compiles records of numbers of packets falling within various size ranges during multiple first time windows to generate a record of numbers of packets falling within the various size ranges during a longer second time window that corresponds to the multiple first time windows. As another illustrative example, the feature extractor 140 compiles records of numbers of IPGs falling within various size ranges during multiple first time windows to generate a record of numbers of IPGs falling within the various size ranges during a longer second time window that corresponds to the multiple first time windows.

Generally speaking, the feature extractor 140 generates statistics for longer second time windows as compared to the first time windows according to which the statistics generator 128 operates. For example, each feature vector corresponds to a longer second time window (e.g., a time window that is longer than the first time windows according to which the statistics generator 128 operates), and the feature vector includes statistics that the feature extractor 140 generates for the longer second time window and that are generated based on statistics from the statistics generator 128 for multiple first time windows that correspond to the longer second time window. In some embodiments in which the statistics generator 128 generates per-flow statistics, a feature vector includes information regarding the flow and statistics corresponding to the flow and for the longer second time window. Information regarding the flow includes one of, or any suitable combination of two or more of: an identifier of a port of a network device via which packets from which the statistics were generated are to be transmitted, an identifier of a queue of the network device that stores packets from which the statistics were generated, a flow identifier, one or more source addresses (e.g., a source IP address, a source MAC address, etc.), one or more destination addresses (e.g., a destination IP address, a destination MAC address, etc.), one or more source port identifiers (e.g., a source TCP port, a source UDP port, etc.), one or more destination port identifiers (e.g., a destination TCP port, a destination UDP port, etc.), a protocol identifier (e.g., an IP version identifier), an Internet Control Message Protocol (ICMP) type, an ICMP code, an address resolution protocol (ARP) opcode, an ARP source MAC address, an ARP source IPv4 address, an ARP destination MAC address, an ARP destination MAC address, etc.

In some embodiments, the feature extractor 140 generates feature vectors at a rate that corresponds to the longer second time window interval and therefore is lower than the packet rate. In other embodiments, the feature extractor 140 generates feature vectors at a rate that corresponds to a time interval that is shorter than the longer second time window interval but still lower than the packet rate.

The rate at which the feature extractor 140 generates feature vectors is less than the packet rate of the network traffic, thus reducing costs of the feature extractor 140 as compared to a feature extractor that must generate feature vectors at the packet rate. Additionally, because the rate at which statistics generator 128 generates the statistics is less than the packet rate of the network traffic, the anomaly detection processor 112 can operate at the lower rate (rather than the packet rate), thus reducing costs of the anomaly detection processor 112 as compared to an anomaly detector that must process statistics at the packet rate.

The feature extractor 140 is coupled to a memory 144 and uses the memory 144 to generate/compile and store statistics such as described above.

In embodiments in which the statistics generator 128 includes the distribution statistics generator 132, the anomaly detection processor 112 is configured to detect anomalies in network traffic using distribution statistics such as described above (e.g., packet size distribution, IPG size distribution, etc.). For example, normal operation of a flow may have a relatively consistent distribution of packet sizes over time, which is learned by the anomaly detection processor 112 during training. Thus, when the distribution of packet sizes in the flow significantly deviates from the consistent packet size distribution, an output of the anomaly detection processor 112 may indicate an anomaly, according to an embodiment. As another example, a flow may have a relatively consistent distribution of IPG sizes over time, which is learned by the anomaly detection processor 112 during training. Thus, when the distribution of IPG sizes in the flow significantly deviates from the consistent IPG size distribution, an output of the anomaly detection processor 112 may indicate an anomaly, according to an embodiment.

In some embodiments in which the feature extractor 140 provides feature vectors at a rate that is lower than the packet rate, the anomaly detection processor 112 operates at the rate that is lower than the packet rate. In some embodiments in which the feature extractor 140 provides feature vectors at the packet rate, the anomaly detection processor 112 samples feature vectors at a rate lower than the packet rate and operates at the rate that is lower than the packet rate. In other embodiments in which the feature extractor 140 provides feature vectors at the packet rate, the anomaly detection processor 112 operates at the packet rate.

In an embodiment, the packet parser 104 and the feature extraction system 108 are implemented using hardware circuitry. For example, the flow classifier 124, the statistics generator 128 and the feature extractor 140 are implemented using respective hardware circuitry. In another embodiment, the packet parser 104 and/or one or more components of the feature extraction system 108 are implemented using a processor that executes machine-readable instructions stored in a memory.

In an embodiment, the anomaly detection processor 112 is implemented using hardware circuitry. In another embodiment, the anomaly detection processor 112 is implemented using a processor that executes machine-readable instructions stored in a memory.

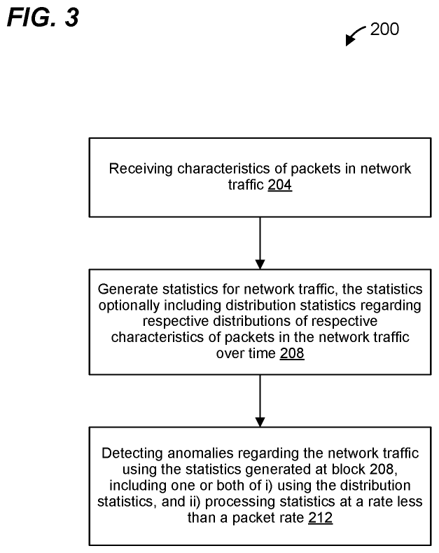

FIG. 3 is a flow diagram of an example method 200 for detecting anomalies in network traffic, according to an embodiment. In an embodiment, the example network traffic anomaly detection system 100 (FIG. 1) implements the method 200, and the method 200 is discussed with reference to FIG. 1 for explanatory purposes. In other embodiments, the method 200 is implemented by another suitable network traffic anomaly detection system.

At block 204, characteristics of packets in network traffic are received. For example, the statistics generator 128 receives characteristics of packets in the network traffic, such as header information extracted from the packets by the packet parser 104 and packet metadata. In some embodiments, the metadata includes timing information regarding packets such as described above.

At block 208, statistics for the network traffic are generated. In some embodiments, the statistics generated at block 208 include distribution statistics regarding respective distributions of respective characteristics of packets in the network traffic over time. For example, the statistics generator 128 (and optionally the distribution statistics generator 132) generates statistics for the network traffic, as discussed above.

In some embodiments in which distribution statistics are generated at block 208, the distribution statistics comprise statistics of distributions of sizes of packets in the network traffic over time. In some embodiments in which distribution statistics are generated at block 208, the distribution statistics comprise respective distributions of sizes of packets in respective packet flows in the network traffic over time, each packet flow comprising packets having respective sets of common packet header information.

In some embodiments in which distribution statistics are generated at block 208, the distribution statistics include statistics of distributions of sizes of IPGs in the network traffic over time. In some embodiments in which distribution statistics are generated at block 208, the distribution statistics include statistics of distributions of sizes of IPGs in respective packet flows in the network traffic over time, each packet flow comprising packets having respective sets of common packet header information.

At block 212, anomalies regarding the network traffic are detected using the statistics generated at block 208. For example, the feature extractor 140 generates feature vectors using the statistics generated at block 208, and the anomaly detection processor 112 detects anomalies using the feature vectors generated by the feature extractor 140. In some embodiments in which the statistics generated at block 208 include statistics of the respective distributions of sizes of packets, detecting anomalies at block 212 includes using the statistics of the respective distributions of sizes of packets. In some embodiments in which the statistics generated at block 208 include statistics of the respective distributions of sizes of packets, detecting anomalies at block 212 includes using the statistics of the respective distributions of sizes of packets in respective packet flows.

In some embodiments, the anomaly detection processor 112 is trained to learn statistics (e.g., corresponding to the statistics generated at block 208) for network traffic that is assumed to be normal, and detecting anomalies at block 212 includes the anomaly detection processor 112 determining a degree of deviation in the statistics generated at block 208 from the statistics for network traffic that is assumed to be normal.

In some embodiments in which the statistics generated at block 208 include statistics of the respective distributions of sizes of IPGs, detecting anomalies at block 212 includes using the statistics of the respective distributions of sizes of IPGs. In some embodiments in which the statistics generated at block 208 include statistics of the respective distributions of sizes of IPGs, detecting anomalies at block 212 includes using the statistics of the respective distributions of IPGs of packets in respective packet flows.

In some embodiments, detecting anomalies at block 212 includes performing, by the anomaly detection processor 112, a process for detecting anomalies at a rate corresponding to a time interval that is at least as long as an aggregate time duration of multiple packets.

In some embodiments, generating statistics for the network traffic at block 208 comprises providing updated statistics for network traffic, including updated distribution statistics regarding the distribution of respective characteristics of packets in the network traffic over time, to the anomaly detection processor 112 at a rate corresponding to the time interval that is at least as long as the aggregate time duration of multiple packets.

In some embodiments, generating the distribution statistics at block 208 comprises generating the distribution statistics regarding respective distributions of respective characteristics of packets in the network traffic over a predetermined time interval; and detecting anomalies in the network traffic at block 212 comprises detecting anomalies in the network traffic that occur during the time interval.

In some embodiments, generating the distribution statistics at block 208 comprises generating the distribution statistics regarding respective distributions of respective characteristics of packets in the network traffic over a time interval that corresponds to a predetermined number of packets in the network traffic; and detecting anomalies in the network traffic at block 212 comprises detecting anomalies the network traffic that occur during the time interval.

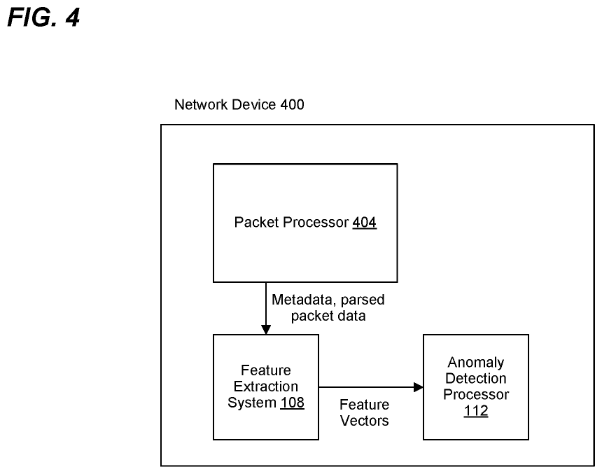

FIG. 4 is a simplified block diagram of an example network device 400 that includes the feature extraction system 108 and the anomaly detection processor 112, according to an embodiment. In various embodiments, the network device 400 is a Layer-2 switch, a router, a bridge, etc.

In some embodiments, the network device 400 includes a plurality of ports (not shown) coupled to a plurality of network links (not shown). The network device 400 includes a packet processor 404 that is configured to process packets received by the network device 400 and to make forwarding decisions for packets (e.g., determine one or more ports of the network device 400 via which packets are to be transmitted). Processing packets by the packet processor 404 includes generating and/or compiling metadata such as described above, parsing headers of packets such as described above, etc. For example, the packet processor 404 includes a packet parser (not shown) such as the packet parser 104 of FIG. 1. The feature extraction system 108 of the network device 400 receives metadata (including timing information) and parsed header data of packets and generates statistics (including distribution statistics, in some embodiments) such as described above. Additionally, the feature extraction system 108 uses the statistics (including distribution statistics, in some embodiments) to generate feature vectors such as described above. The feature vectors provide information (e.g., statistical information including distribution statistics, in some embodiment) regarding network traffic during respective time periods or during transmission of respective sets of N packets that are received by the network device 400. The anomaly detection processor 112 processes the feature vectors and detects anomalies in network traffic received by the network device 404 using the processing of the feature vectors.

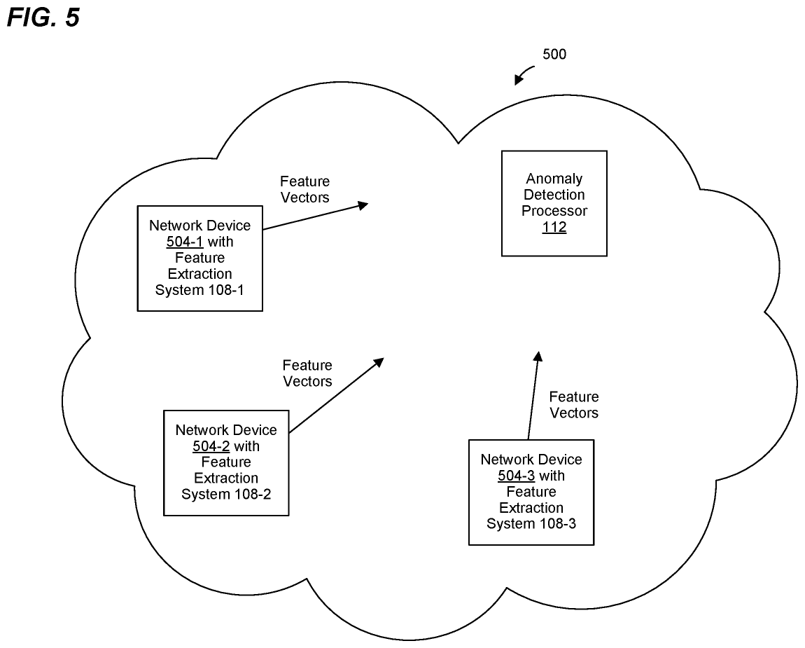

FIG. 5 is a simplified block diagram of an example system 500 that includes a plurality of network devices 504 and the anomaly detection processor 112, according to an embodiment. In various embodiments, each network device 504 is a Layer-2 switch, a router, a bridge, etc. Each network device 504 includes a respective feature extraction system 108 that generates feature vectors such as described above for packets received at the network device 504. In an embodiment, each network device 504 is similar to the network device 400 of FIG. 4 but does not include an anomaly detection system. Each network device 504 transmits feature vectors to the anomaly detection system 112 via communication paths (not shown) in the system 500.

The anomaly detection processor 112 processes the feature vectors received from the network devices 504 and detects anomalies in network traffic received by the network devices 504 using the processing of the feature vectors.

Embodiment 1: An anomaly detection apparatus for detecting anomalies in network traffic, the anomaly detection apparatus comprising: a statistics generator configured to receive characteristics of packets in network traffic and to generate statistics for the network traffic, the statistics including distribution statistics regarding respective distributions of respective characteristics of packets in the network traffic over time; and an anomaly detection processor configured to detect anomalies regarding the network traffic based at least the statistics generated by the statistics generator, including detecting deviations in the distribution statistics as compared to distribution statistics for normal network traffic and detecting anomalies regarding the network traffic based on the deviations in the distribution statistics as compared to distribution statistics for the normal network traffic.

Embodiment 2: The anomaly detection apparatus of embodiment 1, wherein: the statistics generator is configured to generate statistics of distributions of sizes of packets in the network traffic over time; and the anomaly detection processor is configured to detect anomalies regarding the network traffic based on detecting deviations of the statistics of the distributions of sizes of packets in the network traffic as compared to statistics of the distributions of sizes of packets in normal network traffic.

Embodiment 3: The anomaly detection apparatus of embodiment 2, wherein: the statistics generator is configured to generate statistics of respective distributions of sizes of packets in respective packet flows in the network traffic over time; and the anomaly detection processor is configured to detect anomalies regarding respective packet flows in the network traffic based on detecting deviations of the statistics of the respective distributions of sizes of packets in the respective packet flows as compared to statistics of the respective distributions of sizes of packets in normal network traffic in the respective packet flows.

Embodiment 4: The anomaly detection apparatus of any of embodiments 1-3, wherein: the statistics generator is configured to generate statistics of distributions of sizes of inter-packet gaps (IPGs) in the network traffic over time; and the anomaly detection processor is configured to detect anomalies regarding the network traffic based on detecting deviations of the statistics of the distributions of sizes of IPGs as compared to statistics of the distributions of sizes of IPGs in normal network traffic.

Embodiment 5: The anomaly detection apparatus of claim 4, wherein: the statistics generator is configured to generate statistics of respective distributions of IPGs in respective packet flows in the network traffic over time; and the anomaly detection processor is configured to detect anomalies regarding respective packet flows in the network traffic based on detecting deviations of the statistics of the respective distributions of sizes of IPGs in the respective packet flows as compared to statistics of the respective distributions of sizes of IPGs in normal network traffic in the respective packet flows.

Embodiment 6: The anomaly detection apparatus of any of embodiments 1-5, wherein: the anomaly detection processor is configured to perform a process for detecting anomalies at a rate corresponding to a time interval that is at least as long as an aggregate time duration of multiple packets.

Embodiment 7: The anomaly detection apparatus of embodiment 6, further comprising: a feature extractor coupled to the statistics generator, the feature extractor configured to generate compiled distribution statistics regarding the distribution of respective characteristics of packets in the network traffic over time, and to provide the compiled distribution statistics to the anomaly detection processor at the rate corresponding to the time interval that is at least as long as the aggregate time duration of multiple packets.

Embodiment 8: The anomaly detection apparatus of embodiment 7, wherein: the feature extractor is configured to generate the compiled distribution statistics regarding respective distributions of respective characteristics of packets in the network traffic over a predetermined time interval; and the anomaly detection processor is configured to detect anomalies in the network traffic that occur during the time interval.

Embodiment 9: The anomaly detection apparatus of embodiment 7, wherein: the feature extractor is configured to generate the compiled distribution statistics regarding respective distributions of respective characteristics of packets in the network traffic over a time interval that corresponds to a predetermined number of packets in the network traffic; and the anomaly detection processor is configured to detect anomalies in the network traffic that occur during the time interval.

Embodiment 10: A method for detecting anomalies in network traffic, the method comprising: receiving, at feature extraction circuitry, characteristics of packets in network traffic; generating, at the feature extraction circuitry, statistics for the network traffic, the statistics including distribution statistics regarding respective distributions of respective characteristics of packets in the network traffic over time; and detecting, at an anomaly detection processor, anomalies regarding the network traffic based at least the statistics generated by the statistics generator, including detecting deviations in the distribution statistics as compared to distribution statistics for normal network traffic and detecting anomalies regarding the network traffic based on the deviations in the distribution statistics as compared to distribution statistics for the normal network traffic.

Embodiment 11: The method of embodiment 10, wherein: generating distribution statistics comprises generating statistics of distributions of sizes of packets in the network traffic over time; and detecting anomalies regarding the network traffic comprises detecting anomalies based on detecting deviations in the statistics of the distributions of sizes of packets in the network traffic as compared to statistics of the distributions of sizes of packets for normal network traffic.

Embodiment 12: The method of embodiment 11, wherein: generating statistics of distributions of sizes of packets comprises generating statistics of respective distributions of sizes of packets in respective packet flows in the network traffic over time, each packet flow comprising packets having respective sets of common packet header information; and detecting anomalies regarding the network traffic comprises detecting anomalies based on detecting deviations in the statistics of the respective distributions of sizes of packets in the respective packet flows as compared to statistics of the distributions of sizes of packets for normal network traffic in the respective packet flows.

Embodiment 13: The method of any of embodiments 10-12, wherein: generating distribution statistics comprises generating statistics of distributions of sizes of inter-packet gaps (IPGs) in the network traffic over time; and detecting anomalies regarding the network traffic comprises detecting anomalies based on detecting deviations in the statistics of the distributions of sizes of IPGs as compared to statistics of the distributions of sizes of IPGs for normal network traffic.

Embodiment 14: The method of claim 13, wherein: generating statistics of distributions of sizes of IPGs comprises generating statistics of distributions of sizes of IPGs in respective packet flows in the network traffic over time, each packet flow comprising packets having respective sets of common packet header information; and detecting anomalies regarding respective packet flows in the network traffic comprises detecting anomalies based on detecting deviations in the statistics of the respective distributions of sizes of IPGs in the respective packet flows as compared to statistics of the distributions of sizes of IPGs for normal network traffic in the respective packet flows.

Embodiment 15: The method of any of embodiments 10-14, wherein: detecting anomalies regarding the network traffic comprises performing, by the anomaly detection processor, a process for detecting anomalies at a rate corresponding to a time interval that is at least as long as an aggregate time duration of multiple packets.

Embodiment 16: The method of claim 15, further comprising: generating, by the feature extraction circuitry, compiled distribution statistics regarding the distribution of respective characteristics of packets in the network traffic over time; and providing the compiled distribution statistics to the anomaly detection processor at the rate corresponding to the time interval that is at least as long as the aggregate time duration of multiple packets.

Embodiment 17: The method of claim 16, wherein: generating the compiled distribution statistics comprises generating the compiled distribution statistics regarding respective distributions of respective characteristics of packets in the network traffic over a predetermined time interval; and detecting anomalies in the network traffic comprises detecting anomalies in the network traffic that occur during the time interval.

Embodiment 18: The method of claim 16, wherein: generating the compiled distribution statistics comprises generating the compiled distribution statistics regarding respective distributions of respective characteristics of packets in the network traffic over a time interval that corresponds to a predetermined number of packets in the network traffic; and detecting anomalies in the network traffic comprises detecting anomalies the network traffic that occur during the time interval.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any suitable computer readable memory such as a random-access memory (RAM), a read only memory (ROM), a flash memory, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. An anomaly detection apparatus for detecting anomalies in network traffic, the anomaly detection apparatus comprising:
a statistics generator configured to receive characteristics of packets in network traffic and to generate statistics for the network traffic, the statistics including distribution statistics regarding respective distributions of respective characteristics of packets in the network traffic over time; and
an anomaly detection processor configured to detect anomalies regarding the network traffic based at least the statistics generated by the statistics generator, including detecting deviations in the distribution statistics as compared to distribution statistics for normal network traffic and detecting anomalies regarding the network traffic based on the deviations in the distribution statistics as compared to distribution statistics for the normal network traffic.

2. The anomaly detection apparatus of claim 1, wherein:
the statistics generator is configured to generate statistics of distributions of sizes of packets in the network traffic over time; and
the anomaly detection processor is configured to detect anomalies regarding the network traffic based on detecting deviations of the statistics of the distributions of sizes of packets in the network traffic as compared to statistics of the distributions of sizes of packets in normal network traffic.

3. The anomaly detection apparatus of claim 2, wherein:
the statistics generator is configured to generate statistics of respective distributions of sizes of packets in respective packet flows in the network traffic over time; and
the anomaly detection processor is configured to detect anomalies regarding respective packet flows in the network traffic based on detecting deviations of the statistics of the respective distributions of sizes of packets in the respective packet flows as compared to statistics of the respective distributions of sizes of packets in normal network traffic in the respective packet flows.

4. The anomaly detection apparatus of claim 1, wherein:
the statistics generator is configured to generate statistics of distributions of sizes of inter-packet gaps (IPGs) in the network traffic over time; and
the anomaly detection processor is configured to detect anomalies regarding the network traffic based on detecting deviations of the statistics of the distributions of sizes of IPGs as compared to statistics of the distributions of sizes of IPGs in normal network traffic.

5. The anomaly detection apparatus of claim 4, wherein:
the statistics generator is configured to generate statistics of respective distributions of IPGs in respective packet flows in the network traffic over time; and
the anomaly detection processor is configured to detect anomalies regarding respective packet flows in the network traffic based on detecting deviations of the statistics of the respective distributions of sizes of IPGs in the respective packet flows as compared to statistics of the respective distributions of sizes of IPGs in normal network traffic in the respective packet flows.

6. The anomaly detection apparatus of claim 1, wherein:
the anomaly detection processor is configured to perform a process for detecting anomalies at a rate corresponding to a time interval that is at least as long as an aggregate time duration of multiple packets.

7. The anomaly detection apparatus of claim 6, further comprising:
a feature extractor coupled to the statistics generator, the feature extractor configured to generate compiled distribution statistics regarding the distribution of respective characteristics of packets in the network traffic over time, and to provide the compiled distribution statistics to the anomaly detection processor at the rate corresponding to the time interval that is at least as long as the aggregate time duration of multiple packets.

8. The anomaly detection apparatus of claim 7, wherein:
the feature extractor is configured to generate the compiled distribution statistics regarding respective distributions of respective characteristics of packets in the network traffic over a predetermined time interval; and
the anomaly detection processor is configured to detect anomalies in the network traffic that occur during the time interval.

9. The anomaly detection apparatus of claim 7, wherein:
the feature extractor is configured to generate the compiled distribution statistics regarding respective distributions of respective characteristics of packets in the network traffic over a time interval that corresponds to a predetermined number of packets in the network traffic; and
the anomaly detection processor is configured to detect anomalies in the network traffic that occur during the time interval.

10. A method for detecting anomalies in network traffic, the method comprising:
receiving, at feature extraction circuitry, characteristics of packets in network traffic;
generating, at the feature extraction circuitry, statistics for the network traffic, the statistics including distribution statistics regarding respective distributions of respective characteristics of packets in the network traffic over time; and
detecting, at an anomaly detection processor, anomalies regarding the network traffic based at least the statistics generated by the statistics generator, including detecting deviations in the distribution statistics as compared to distribution statistics for normal network traffic and detecting anomalies regarding the network traffic based on the deviations in the distribution statistics as compared to distribution statistics for the normal network traffic.

11. The method of claim 10, wherein:
generating distribution statistics comprises generating statistics of distributions of sizes of packets in the network traffic over time; and
detecting anomalies regarding the network traffic comprises detecting anomalies based on detecting deviations in the statistics of the distributions of sizes of packets in the network traffic as compared to statistics of the distributions of sizes of packets for normal network traffic.

12. The method of claim 11, wherein:
generating statistics of distributions of sizes of packets comprises generating statistics of respective distributions of sizes of packets in respective packet flows in the network traffic over time, each packet flow comprising packets having respective sets of common packet header information; and
detecting anomalies regarding the network traffic comprises detecting anomalies based on detecting deviations in the statistics of the respective distributions of sizes of packets in the respective packet flows as compared to statistics of the distributions of sizes of packets for normal network traffic in the respective packet flows.

13. The method of claim 10, wherein:
generating distribution statistics comprises generating statistics of distributions of sizes of inter-packet gaps (IPGs) in the network traffic over time; and
detecting anomalies regarding the network traffic comprises detecting anomalies based on detecting deviations in the statistics of the distributions of sizes of IPGs as compared to statistics of the distributions of sizes of IPGs for normal network traffic.

14. The method of claim 13, wherein:
generating statistics of distributions of sizes of IPGs comprises generating statistics of distributions of sizes of IPGs in respective packet flows in the network traffic over time, each packet flow comprising packets having respective sets of common packet header information; and
detecting anomalies regarding respective packet flows in the network traffic comprises detecting anomalies based on detecting deviations in the statistics of the respective distributions of sizes of IPGs in the respective packet flows as compared to statistics of the distributions of sizes of IPGs for normal network traffic in the respective packet flows.

15. The method of claim 10, wherein:
detecting anomalies regarding the network traffic comprises performing, by the anomaly detection processor, a process for detecting anomalies at a rate corresponding to a time interval that is at least as long as an aggregate time duration of multiple packets.

16. The method of claim 15, further comprising:
generating, by the feature extraction circuitry, compiled distribution statistics regarding the distribution of respective characteristics of packets in the network traffic over time; and
providing the compiled distribution statistics to the anomaly detection processor at the rate corresponding to the time interval that is at least as long as the aggregate time duration of multiple packets.

17. The method of claim 16, wherein:
generating the compiled distribution statistics comprises generating the compiled distribution statistics regarding respective distributions of respective characteristics of packets in the network traffic over a predetermined time interval; and
detecting anomalies in the network traffic comprises detecting anomalies in the network traffic that occur during the time interval.

18. The method of claim 16, wherein:
generating the compiled distribution statistics comprises generating the compiled distribution statistics regarding respective distributions of respective characteristics of packets in the network traffic over a time interval that corresponds to a predetermined number of packets in the network traffic; and
detecting anomalies in the network traffic comprises detecting anomalies the network traffic that occur during the time interval.
